(19) United States
(12) Patent Application Publication
(10) Pub. No.: US 2022/0378664 A1
(43) Pub. Date: Dec. 1, 2022

(54) AIR REPLENISH VALVE FOR A DRINKING CUP OR FEEDING BOTTLE

(71) Applicant: KONINKLIJKE PHILIPS N.V., EINDHOVEN (NL)

(72) Inventors: Flavio Emilio COVI, EINDHOVEN (NL); Amir Masoud Akbari PAZOOKI, ARNHEM (NL); Lokesh PATHIPATI, BATAM ISLAND (ID); Mawe SINAGA, BATAM ISLAND (ID); Cheng Keat TAN, SINGAPORE (SG)

(21) Appl. No.: 17/771,518

(22) PCT Filed: Oct. 28, 2020
(86) PCT No.: PCT/EP2020/080218

§ 371 Date: Apr. 25, 2022

(30) Foreign Application Priority Data
Nov. 7, 2019 (EP) 19207654.5

(51) Int. Cl. A61J 11/02; A47G 19/22

(52) U.S. Cl. CPC A61J 11/02; A47G 19/2272

(57) ABSTRACT

The invention provides an air replenish valve for a drinking cup or feeding bottle, having a duckbill slit valve. First and second stiffening portions are provided at the ends of the slit as stiffening regions of the end walls. These assist in providing a desired valve function while also making reliable manufacture easier to achieve.

### FIELD OF THE INVENTION

This invention relates to an air replenish valve for a drinking cup or feeding bottle.

### BACKGROUND OF THE INVENTION

Drinking cups for children (sometimes known as toddler cups) are used by parents to feed pulp-free liquids to toddlers. Typically, these cups have a soft, flexible spout or a hard spout. Baby feeding bottles are typically used for feeding milk to a baby. A soft teat is used which replicates a mother's nipple.

It is common additionally to have an air replenish (air venting) valve to allow air to enter the cup or bottle when liquid is drunk from the cup or bottle. This allows the toddler or baby to drink continuously without the need to release the bottle.

A common air replenish valve is a duckbill type of valve, having two flaps that touch (or almost touch) each other at a slit to prevent liquid flowing out but to allow air to enter the bottle when there is a certain under-pressure in the bottle. The pressure difference acts across the flaps and causes them to deform in response to the under-pressure and hence open the valve slit.

However these valves are notoriously difficult to manufacture and often have a low yield of leak-proof valves. Also, if using cutting to form the slit valve opening, the material at the valve opening may bond together again after the cutting process.

WO 2011/049255 discloses an air valve forming part of a teat. The valve has sides which converge to form a slit sloped end walls at the ends of the slit.

WO 2015/078797 discloses an injection molded slit valve.

U.S. Pat. No. 2,644,663 discloses a check valve formed as a slit with ends walls formed as separate end parts.

US 2005/252875 discloses an air intake valve based on a slit across a circular projection.

U.S. Pat. No. 5,431,290 shows another slit valve design.

US 2007/244426 discloses a duckbill valve including protuberances at the ends of the valve slit to resist tearing of the slit when an inserted instrument passes through the slit.

WO 2010/107723 discloses another duckbill valve.

WO 2015/013362 discloses a feeding bottle using a cross shaped valve.

There is therefore a need for an improved valve design.

### SUMMARY OF THE INVENTION

The invention is defined by the claims.

According to examples in accordance with an aspect of the invention, there is provided an air replenish valve for a drinking cup or feeding bottle having an air side and a cup or bottle side, comprising:

an orifice at the air side;

first and second side walls which face each other and project in the direction of the cup or bottle side, wherein the first and second side walls slope towards each other to form a narrow elongate slit at their cup or bottle side ends to form a duckbill valve; and

first and second end walls which connect the side walls,

wherein the valve further comprises first and second stiffening portions comprising stiffening regions of the end walls, or stiffening regions between each end walls and a respective end of the slit, and extending between the first and second side walls.

Each stiffening potion may be in the vicinity of said respective end of the slit.

This valve has a duckbill slit valve function, using tapering side walls. The pressure applied to the side walls opens or closes the valve. Thus, if there is a reduced pressure at the drinking cup or feeding bottle side, the valve opens to allow air to flow from the air side to replenish air in the cup or bottle. To make the manufacture of the valve more simple, stiffening stiffening portions are provided at the ends of the slit—either at the end walls, or between the slit end and the proximal end wall. The design of these stiffening elements ensures the correct valve function while also simplifying manufacture, in particular by allowing the slit to be formed more reliably during manufacture rather than as an additional post manufacture step.

The main body of the valve may be made from a thin layer hence saving material cost, because the stiffening portions provide the required stiffness to enable the reliable formation of the valve slit.

The orifice is a larger opening such as an oval, circle, rectangle or other shaped opening. It provides a permanent opening into a valve space defined between the side walls.

The stiffening portions may comprise regions of different material or else regions of different geometry to the remainder of the end wall, or else formed a elements near to the end wall (between the end wall and the nearest end of the slit).

They provide an increased degree of mechanical coupling between the side walls. This mechanical coupling may be considered to form a “bridge” between the side walls. They may contact directly and extend between the side walls, and thereby form a connection between the side walls, but the bridge may instead be more indirect. It may only be a portion of the span between the side walls.

The first and second stiffening portions for example each comprise a region of a respective end wall formed form a stiffer material than the remainder of the end wall. This provides local strengthening and stiffening.

The first and second stiffening portions may instead comprise a locally thicker region of the respective end wall. This means a uniform material may be used, giving a simple manufacturing process, such as molding.

Each stiffening portion may comprise a projection on the inside of a respective end wall facing inwardly into the space between the first and second side walls. This provides increased rigidity at the ends of the slit. The added thickness is inside the previous outer contour of the valve so does not take up additional space.

Each stiffening portion may comprise a sloped ramp which slopes from a ridge on the inside surface of the end wall down to the slit. This provides a chamfered surface to give a local thickness change.

Each stiffening portion may instead comprise a projection on the outside of a respective end wall facing outwardly from the space between the first and second side walls. In this way, the projection does not change the internal design of the slit.

Each stiffening portion may comprise a sloped ramp which slopes from a ridge on the outside surface of the end wall down to the bottom of the side walls.

The first and second stiffening portions may instead each be located between a respective end wall and the local end of the slit. For example, the slit may be formed in a generally planar area, and this planar area may then have ribs or other strengthening structures performing the bridge function between the side walls.

The valve is preferably a molded component, wherein the slit is formed as part of the mold. Thus, in-mold slitting may be used. The stiffening portions make the molding of the slit more reliable.

The invention also provides a teat for a feeding bottle or a lid for a drinking cup, comprising a drinking orifice and a valve as defined above. The drinking orifice and valve are for example formed in a single molded component.

The invention also provides a portioning component for a feeding bottle comprising a valve as defined above. Such a feeding bottle comprises a teat component for dispensing food and a bottle component for holding the food. The partitioning component divides the inner volume of the bottle into a teat volume on the side of the teat and a bottle volume on the side of the bottle. The partitioning component may have a valve as defined above to ensure filing of the teat volume with food.

The invention also provides a drinking cup or feeding bottle, comprising:

a main body;

a lid or teat;

a drinking orifice in the lid or teat; and

a valve as defined above between the main body and the ambient surroundings.

The invention also provides mold for forming an air replenish valve for a drinking cup or feeding bottle, the air replenish valve having an air side and a cup or bottle side, the mold comprising mold portions for forming:

an orifice at the air side;

first and second side walls which face each other and project in the direction of the cup or bottle side,

a narrow elongate slit to form a duckbill valve, wherein the first and second side walls slope towards each other to form the slit at their cup or bottle side ends;

first and second end walls which connect the side walls; and

first and second stiffening portions comprising locally thicker regions of the end walls each in the vicinity of a respective end of the slit and extending the first and second side walls.

The shape of the mold is used to form the stiffening portions.

Mold portions are for example provided for forming each stiffening portion as a projection on the inside of a respective end wall facing inwardly into the space between the first and second side walls. Alternatively, mold portions may be provided for forming each stiffening portion as a projection on the outside of a respective end wall facing outwardly from the space between the first and second side walls.

The invention also provides a method of manufacturing an air replenish valve for a drinking cup or feeding bottle, the method comprising using the mold defined above.

These and other aspects of the invention will be apparent from and elucidated with reference to the embodiment(s) described hereinafter.

### BRIEF DESCRIPTION OF THE DRAWINGS

For a better understanding of the invention, and to show more clearly how it may be carried into effect, reference will now be made, by way of example only, to the accompanying drawings, in which:

FIG. 1 shows a drinking cup;

FIG. 2 shows a typical design of a duckbill valve, viewed from above and in cross section;

FIG. 3 shows a modification to the valve of FIG. 2 in accordance with an example of the invention;

FIG. 4 shows one example of valve design in more detail;

FIG. 5 is a cross section through line A-A of FIG. 4;

FIG. 6 is a cross section through line B-B of FIG. 4;

FIG. 7 shows another example of valve design in more detail;

FIG. 8 is a cross section through line A-A of FIG. 7; and

FIG. 9 is a cross section through line B-B of FIG. 7.

### DETAILED DESCRIPTION OF THE EMBODIMENTS

The invention will be described with reference to the Figures.

It should be understood that the detailed description and specific examples, while indicating exemplary embodiments of the apparatus, systems and methods, are intended for purposes of illustration only and are not intended to limit the scope of the invention. These and other features, aspects, and advantages of the apparatus, systems and methods of the present invention will become better understood from the following description, appended claims, and accompanying drawings. It should be understood that the Figures are merely schematic and are not drawn to scale. It should also be understood that the same reference numerals are used throughout the Figures to indicate the same or similar parts.

The invention provides an air replenish valve for a drinking cup or feeding bottle, having a duckbill slit valve. First and second stiffening portions are provided at the ends of the slit as stiffening regions of (or near) the end walls. These assist in providing a desired valve function while also making reliable manufacture easier to achieve.

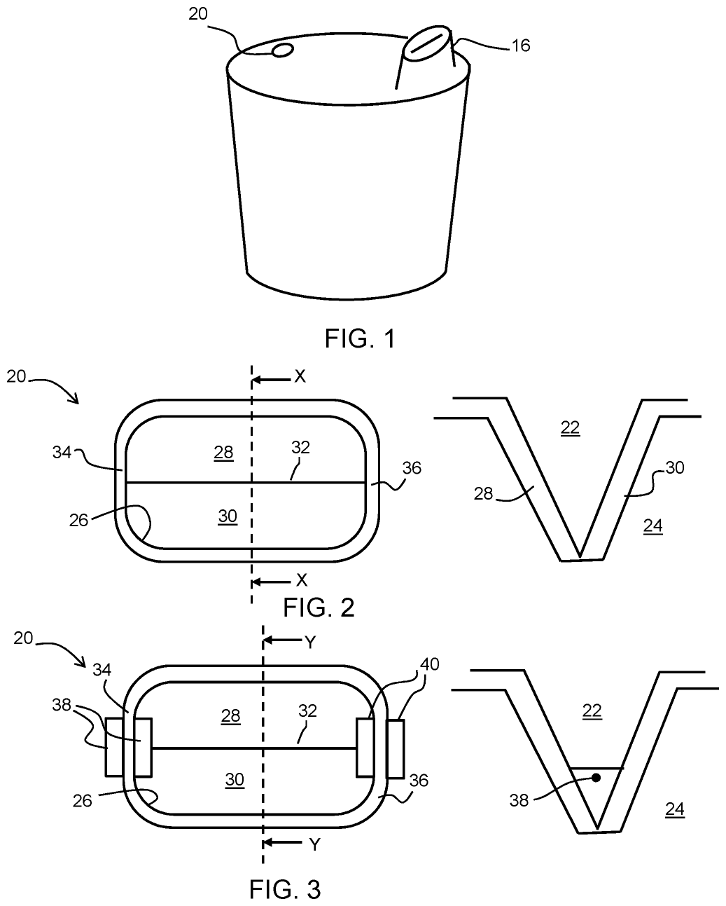

FIG. 1 shows a drinking cup 10, comprising a main body 12, a lid 14 and a drinking spout 16 in the lid, the drinking spout having an orifice through which drinking takes place. The invention will be described with reference to a drinking cup, but the same concept may be applied to a feeding bottle. In such a case, the spout is instead a teat, with a teat orifice. The main body is then the main bottle part.

An air replenish valve 20 is provided between the main cup body and the ambient surroundings. This allow air to flow into the cup body in response to a reduced pressure, caused by the removal of liquid from the cup body by drinking. The valve 20 thus equalizes the inside and outside pressure.

The cup body is typically a rigid plastic, and the air replenish valve is an insert of a softer material which deforms in response to pressure differences.

The air replenish valve may be formed from the same single insert as is used to form the drinking orifice in the spout. Thus, the spout and the air valve may be an integral unit. Similarly, for a feeding bottle, the spout is instead a baby bottle teat, and the air valve may be formed integrally with the teat.

A duckbill valve is one known valve design which may be used as a passive air replenish valve.

FIG. 2 shows a typical design of a duckbill valve, viewed from above (i.e. looking down into the cavity formed within the duckbill valve) and in cross section along the line X-X.

This is a schematic representation.

The valve has an air side 22 and a drinking cup side 24. An orifice 26 is provided at the air side 22 allowing air to flow to a central valve space.

First and second side walls 28,30 face each other and project in the direction of the drinking cup side 24. They slope towards each other to form a narrow elongate slit 32 at their drinking cup side ends to form the duckbill valve. First and second end walls 34,36 connect the side walls.

In the simplified schematic image of FIG. 2, the side walls are generally planar and they meet at the slit. There may in fact be a lip at the bottom of each side wall, and the slit is formed between these lips. The lips are part of the side walls, so the side walls still may be considered to define the elongate slit.

In the simplified schematic image of FIG. 2 (and FIG. 3), the end walls may be considered to be vertical (i.e. perpendicular to the plane of the image) and only the side walls taper to form the slit.

It is noted that the four walls defined above are typically formed as a continuous structure, and may be curved as shown so that there is not a clear boundary between the side walls and the end walls. The end walls may also taper inwardly. However, there are sides which meet at the slit, and where these sides open apart, the ends are closed to form a closed valve space (open only by the slit). Thus, regions near the ends of the slit and generally perpendicular to the slit may be considered to be end walls and regions along the length of the slit and generally parallel to the slit may be considered to be side walls.

This valve design may have low yield, as a result of samples which do not provide an acceptable seal to the liquid in the cup.

The invention provides a modification as shown in FIG. 3. FIG. 3 shows a modified design of a duckbill valve, viewed from above and in cross section along the line Y-Y.

The valve further comprises first and second stiffening portions 38,40. The will be named bridge elements 38,40 in the description that follows. They comprise stiffening regions of the end walls 34,36. Each bridge element 38,40 is in the vicinity of a respective end of the slit. They are stiffening in that they inhibit the opening and closing of the slit valve at their location.

The bridge elements 38,40 may be projections on the inside of the end walls, projections on the outside of the end walls, or formed as a region of different material property with no geometric change.

By way of example, the main body of the valve may be liquid silicon rubber (LSR) (e.g. with a Young's modulus 0.05 GPa) whereas the bridge elements may be formed as stiffer regions formed from polypropylene (e.g. with a Young's modulus 0.05 GPa). A two-shot molding process may be used for this purpose.

Of course other combinations of materials are also possible.

FIG. 3 shows the combination of inward and outward projecting regions. In this case, the projections serve to increase the thickness of the end walls. Inward projecting regions have the effect of reducing the slit length.

The bridge elements bridge across the side walls. This means they provide a coupling between the side walls, to increase the stiffness, and hence make the slit more resistant to opening at the ends of the slit.

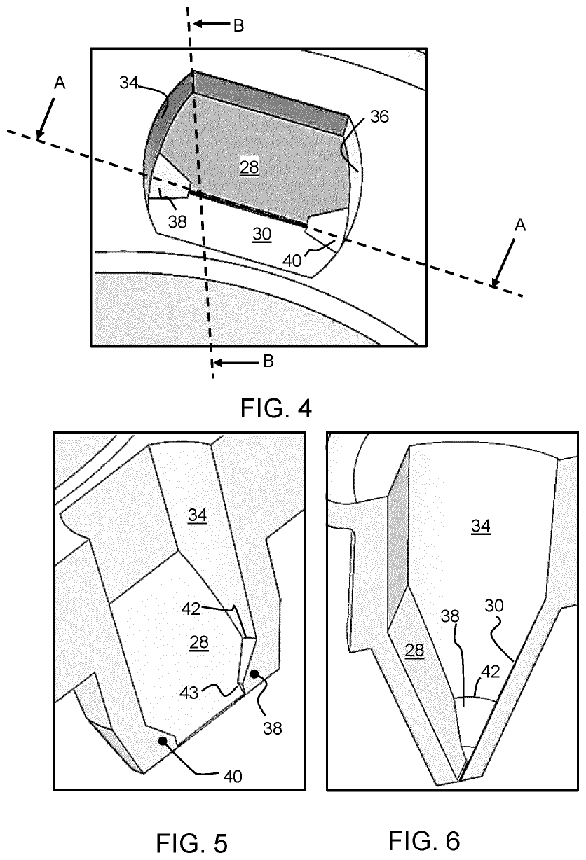

FIG. 4 shows one example of valve design in more detail using inward facing projections 38,40.

FIG. 5 is a cross section through line A-A of FIG. 4 and FIG. 6 is a cross section through line B-B of FIG. 4.

The first and second bridge elements in this design are thus in the form of projections, which create a locally thicker region of the end wall. The projection is on the inside of the end wall facing inwardly into the space between the first and second side walls.

As the projection is on the inside, it directly forms a bridge between the side walls 28,30 thereby limiting the ability of the valve to open and close in the vicinity of the ends of the slit.

Each bridge element 38,40 comprises a sloped ramp which slopes from a ridge 42 on the inside surface of the respective end wall down to the slit 32. There is a transition from the sloped ramp to an upright 43 at the bottom of the sloped ramp.

As mentioned above, the material of the valve is for example liquid silicone rubber (LSR).

By way of example the orifice at the air side has dimensions in the mm range, such as 2 mm to 5 mm length or width.

The slit has an opening width in the range 0 to 0.030 mm and a length in the range of approximately 1 mm to 3 mm.

The depth of the valve space (i.e. the depth of the flexible parts of the side walls) is approximately 2 mm, so typically also in the range 1 mm to 3 mm.

The slope angle of the sides is for example between 12 and 24 degrees.

The thickness of the side walls is for example 0.35 mm (e.g. between 0.2 mm and 0.5 mm) to provide the desired flexibility for the valve function. The end walls for example have a thickness in the is for example approximately 0.45 mm (e.g. between 0.3 mm and 1.0 mm).

The chamfer for example has a 45 degree slope (e.g. between 20 degrees and 60 degrees).

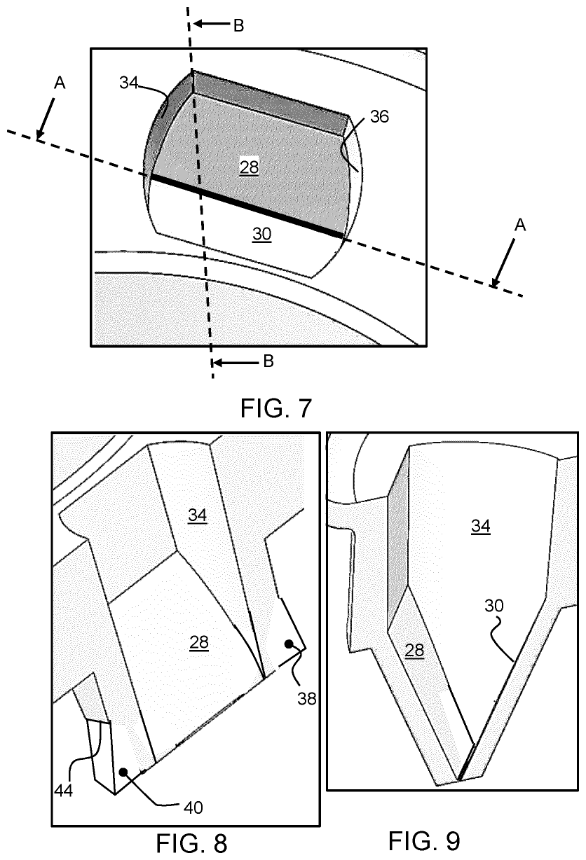

FIG. 7 shows another example of valve design in more detail using outward facing projections 38,40.

FIG. 8 is a cross section through line A-A of FIG. 7 and FIG. 9 is a cross section through line B-B of FIG. 7.

The same general dimensions and materials apply as outlined above for FIGS. 4 to 6 (although a smaller slope of the bridge elements is shown of around 25 degrees).

The first and second bridge elements in this design are again in the form of projections, which create a locally thicker region of the end wall. The projections are on the outside of the end walls facing outwardly from the space between the first and second side walls. As each projection is on the outside, it does not change the internal dimensions of the valve. The additional coupling between the side walls caused by the bridge elements again limits the ability of the valve to open and close in the vicinity of the ends of the slit.

Each bridge element comprises a sloped ramp which slopes from a ridge 44 on the outside surface of the respective end wall down to the bottom of the side walls.

As mentioned above, the valve is preferably formed as a molded component. The stiffening assists in forming the slit as part of the mold rather than after manufacture. In particular, the valve may be manufactured using a single step molding process.

The air replenish valve may be formed in a lid of a cup as shown. However, it may instead be formed in an internal partition within a cup, or it may be formed in a teat or drinking spout (so the drinking valve and air replenish valve are close together in a single component).

Variations to the disclosed embodiments can be understood and effected by those skilled in the art in practicing the claimed invention, from a study of the drawings, the disclosure and the appended claims. In the claims, the word “comprising” does not exclude other elements or steps, and the indefinite article “a” or “an” does not exclude a plurality.

The mere fact that certain measures are recited in mutually different dependent claims does not indicate that a combination of these measures cannot be used to advantage.

If the term “adapted to” is used in the claims or description, it is noted the term “adapted to” is intended to be equivalent to the term “configured to”.

Any reference signs in the claims should not be construed as limiting the scope.

1. An air replenish valve for a drinking cup or feeding bottle having an air side and a cup or bottle side, comprising:
an orifice at the air side;
first and second side walls which face each other and project in the direction of the cup or bottle side, wherein the first and second side walls slope towards each other to form a narrow elongate slit at ends corresponding to the bottle or cup side to form a duckbill valve;
first and second end walls which connect the side walls;
first and second stiffening portions comprising stiffening regions of the end walls, or stiffening regions between each end wall and a respective end of the slit, and extending between the first and second side walls,
wherein the first and second stiffening portions each comprise:
a region of a respective end wall formed from a stiffer material than a remainder of the end wall, or
a locally thicker region of the respective end wall.

2. (canceled)

3. (canceled)

4. The valve as claimed in claim 1, wherein the each stiffening portion further comprises a projection on the inside of a respective end wall facing inwardly into a space between the first and second side walls.

5. The valve as claimed in claim 4, wherein the each stiffening portion further comprises a sloped ramp which slopes from a ridge on an inside surface of the respective end wall down to the slit.

6. The valve as claimed in claim 1, wherein the each stiffening portion further comprises a projection on the outside of a respective end wall facing outwardly from the space between the first and second side walls.

7. The valve as claimed in claim 6, wherein the each stiffening portion comprises a sloped ramp which slopes from a ridge on an outside surface of the respective end wall down to a bottom of the side walls.

8. The valve as claimed in claim 1, further comprising a molded component, wherein the slit is formed as part of the molded component.

9. A teat for a feeding bottle or a lid for a drinking cup, comprising:
a drinking orifice; and
a valve as claimed in claim 1.

10. A partitioning component for a feeding bottle, comprising:
a valve as claimed in claim 1.

11. A drinking cup or feeding bottle, comprising:
a main body;
a lid or teat;
a drinking orifice in the lid or teat; and
a valve as claimed in claim 1 between the main body and ambient surroundings.

12. A mold for forming an air replenish valve for a drinking cup or feeding bottle, the air replenish valve having an air side and a cup or bottle side, the mold comprising mold portions for forming:
an orifice at the air side;
first and second side walls which face each other and project in the direction of the cup or bottle side,
a narrow elongate slit to form a duckbill valve, wherein the first and second side walls slope towards each other to form the slit at ends corresponding to the cup or bottle side;
first and second end walls which connect the side walls; and
first and second stiffening portions comprising locally thicker regions of the end walls each in the vicinity of a respective end of the slit and extending between the first and second side walls.

13. The mold as claimed in claim 12, comprising mold portions for forming each stiffening portion as a projection on the inside of a respective end wall facing inwardly into the space between the first and second side walls.

14. The mold as claimed in claim 12, comprising mold portions for forming each stiffening portion as a projection on the outside of a respective end wall facing outwardly from the space between the first and second side walls.

15. A method of manufacturing an air replenish valve for a drinking cup or feeding bottle, the method comprising using the mold of claim 12 to mold the valve.
